(19) United States
(12) Patent Application Publication
(10) Pub. No.: US 2025/0274045 A1
(43) Pub. Date: Aug. 28, 2025

(54) ADAPTIVE DIODE EMULATION MODE OFFSET CIRCUIT

(71) Applicant: Microchip Technology Incorporated, Chandler, AZ (US)

(72) Inventor: Joseph Depew, Johns Island, SC (US)

(73) Assignee: Microchip Technology Incorporated, Chandler, AZ (US)

(21) Appl. No.: 18/648,625

(22) Filed: Apr. 29, 2024

Related U.S. Application Data
(60) Provisional application No. 63/558,252, filed on Feb. 27, 2024.

(51) Int. Cl. H02M 3/158; H02M 1/00

(52) U.S. Cl. CPC H02M 3/158; H02M 1/0009

(57) ABSTRACT

An apparatus and method for an adaptive diode emulation mode offset circuit is disclosed. The apparatus includes a polarity detection circuit to identify the polarity of a phase node of a DC-DC converter; and an adaptive diode emulation mode (DEM) offset circuit to: detect a first early termination or a first late termination of an on time of a low-side gate drive of the DC-DC converter based on the identified polarity of the phase node; and output an offset voltage to selectively terminate on time of the low-side gate drive to mitigate a second early termination or a second late termination of the low-side gate drive, a value of the offset voltage based on a polarity of the phase node of the DC-DC converter; wherein the second early termination occurs after the first early termination and the second late termination occurs after the first late termination.

### PRIORITY

This application claims priority to U.S. Provisional Patent Application No. 63/558,252, filed Feb. 27, 2024, the contents of which are hereby incorporated in their entirety.

### TECHNICAL FIELD

The present disclosure relates to a diode emulation mode circuit, specifically a diode emulation mode circuit with improved light-load efficiency.

### BACKGROUND

Switch mode power supplies or switching regulators, also referred to as DC to DC converters, are often used to convert an input supply voltage to a desired output voltage. For example, a 5 volts supply voltage provided to an integrated circuit may need to be reduced to 2.8 volts to operate additional circuitry. A switching regulator provides power supply function through low loss components such as capacitors, inductors, and transformers, and power switches that are turned on and off to transfer energy from the input to the output in discrete packets. A feedback control circuit is used to regulate the energy transfer to maintain a constant output voltage within the desired load limits of the circuit.

A switching regulator can be configured to step up the input voltage or step down the input voltage or both. Specifically, a buck switching regulator, also called a “buck converter,” steps down the input voltage while a boost switching regulator, also called a “boost converter,” steps up the input voltage. A buck-boost switching regulator, or buck-boost converter, provides both step-up and step-down functions.

A conventional buck switching regulator includes a pair of power switches which are turned on and off to regulate an output voltage to be proportional to a reference voltage. More specifically, the power switches are alternately turned on and off to generate a switching output voltage at a switching output node, also referred to as the phase node. The phase node is coupled to an LC filter circuit including an output inductor and an output capacitor to generate an output voltage having substantially constant magnitude. The output voltage can then be used to drive a load.

In particular, the pair of power switches is often referred to as including a “high-side power switch” and a “low-side power switch.” The high-side power switch is turned on, or closed, to apply energy to the output inductor of the output filter circuit to allow the current through the inductor to build up. When the high-side power switch is turned off, or opened, the voltage across the inductor reverses and the current through the inductor reduces during this period.

The low-side power switch may be a diode, but as output voltages from DC-to-DC converters have gone down in magnitude, the low-side power switch may be replaced with a transistor to improve efficiency. However, unlike a diode, a transistor, such as a field effect transistor (FET) is a bi-directional switch, allowing current to flow in either direction. When the DC-to-DC converter operates under light current loads, the current in the inductor may fall to zero and even reverse. Reversed current reduces the efficiency of the DC-to-DC converter. To prevent reversal of current flow, diode emulation mode (DEM) circuitry may be added to detect when the inductor current goes to zero at which point the DEM circuitry turns the transistor off such that reverse current cannot flow.

Timing of the DEM circuitry is challenging and may be affected by many system parameters including, for example, the current ramp rate of the inductor, offset and propagation delay of the comparator in the DEM circuit, gate drive path propagation delay, operating temperature, and part-to-part variation. The DEM circuitry turning the low-side power switch off early, or late, can result in increased power dissipation, decreased efficiency, and performance differences between parts. Thus, there is a need for DEM circuitry that can achieve a more accurate low-side power switch termination time.

### SUMMARY OF THE INVENTION

Systems and methods for an adaptive diode emulation mode offset circuit are disclosed. The apparatus includes a polarity detection circuit to identify the polarity of a phase node of a DC-DC converter; and an adaptive diode emulation mode (DEM) offset circuit to: detect a first early termination or a first late termination of an on time of a low-side gate drive of the DC-DC converter based on the identified polarity of the phase node; and output an offset voltage to selectively terminate on time of the low-side gate drive to mitigate a second early termination or a second late termination of the low-side gate drive, a value of the offset voltage based on a polarity of the phase node of the DC-DC converter; wherein the second early termination occurs after the first early termination and the second late termination occurs after the first late termination.

An apparatus includes a DC-DC converter including a low-side gate drive and a phase node, a polarity detection circuit to identify a polarity of the phase node, an adaptive diode emulation mode (DEM) offset circuit, and a DEM circuit. The adaptive DEM offset circuit to: receive the identified polarity of the phase node from the polarity detection circuit; detect a first early termination or a first late termination of an on time of the low-side gate drive based on the identified polarity of the phase node; and output an offset voltage, a value of the offset voltage based on the polarity of the phase node. The DEM circuit to: receive the offset voltage; and selectively terminate the on time of the low-side gate drive to mitigate a second early termination or a second late termination of the low-side gate drive.

A method includes receiving a polarity of a phase node of a DC-DC converter; detecting a first early termination or a first late termination of an on time of a low-side gate drive of the DC-DC converter based on the received polarity of the phase node; and outputting an offset voltage to selectively terminate the on time of the low-side gate drive to mitigate a second early termination or a second late termination of the on time of the low-side gate drive, a value of the offset voltage based on a polarity of a phase node.

### BRIEF DESCRIPTION OF THE DRAWINGS

The figures illustrate examples of systems and methods.

FIG. 1 illustrates a system including an adaptive DEM circuit in a DC-DC converter, according to examples of the present disclosure;

FIG. 2 illustrates an DC-to-DC converter, according to examples of the present disclosure;

FIG. 3 illustrates a polarity detection circuit, according to examples of the present disclosure;

FIG. 4 illustrates an adaptive DEM offset circuit, according to examples of the present disclosure;

FIG. 5 illustrates a DEM circuit, according to examples of the present disclosure;

FIG. 6 illustrates simulation results of a DC-to-DC converter containing an adaptive DEM offset circuit, according to examples of the present disclosure;

FIG. 7 illustrates a method performed for using an adaptive DEM circuit in a DC-DC converter, according to examples of the present disclosure; and

FIG. 8 illustrates a more detailed version of the method described in FIG. 7, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, an adaptive diode emulation mode (DEM) offset circuit is provided. The DEM offset circuit achieves more accurate timing for terminating a switch in a direct current (DC) to DC converter to improve the efficiency of the DC-to-DC converter.

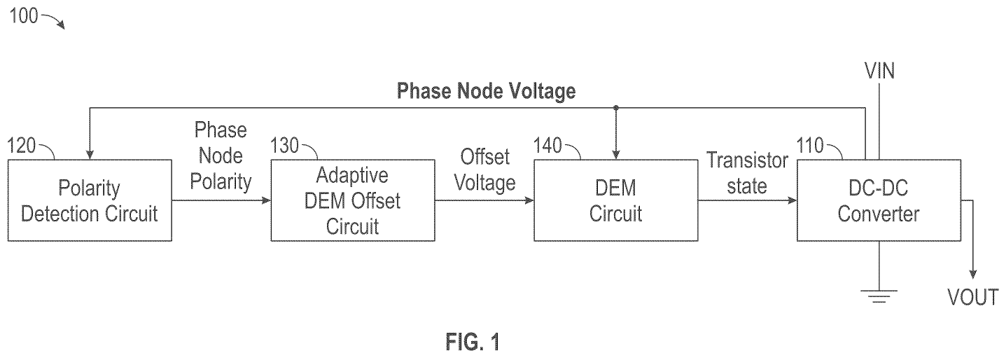

FIG. 1 illustrates a system including an adaptive DEM circuit in a DC-to-DC converter, according to examples of the present disclosure. System 100 may include DC-to-DC converter 110, polarity detection circuit 120, adaptive DEM offset circuit 130, and DEM circuit 140.

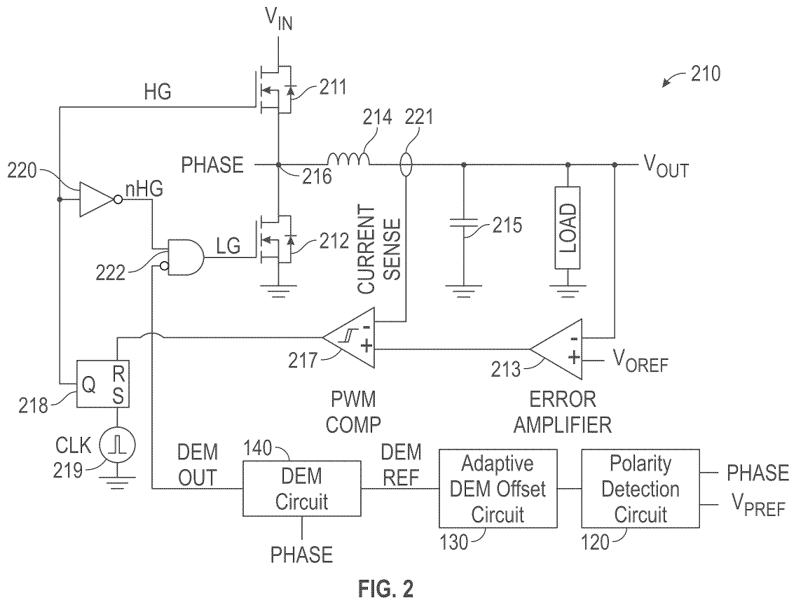

DC-to-DC converter 110 may be a circuit to convert direct current from one voltage to another voltage, such as a step-down (buck) converter, step-up (boost) converter, or a buck-boost converter. DC-to-DC converter 110 may be connected to an input voltage (V_{IN}) and ground (GND), or other return. DC-to-DC converter 110 may include two gate drives (e.g., a high-side gate drive and a low-side gate drive) and at least one energy storage element, such as a capacitor, an inductor, or any combination thereof. In some examples, one of the gate drives may be a transistor, such as a field effect transistor (FET). The state of the low-side gate drive in DC-to-DC converter 110 may be controlled by DEM circuit 140 to time the termination of the on time of the low-side gate drive to improve the efficiency of DC-to-DC converter 110. A more detailed example of DC-to-DC converter 110 is shown in FIG. 2.

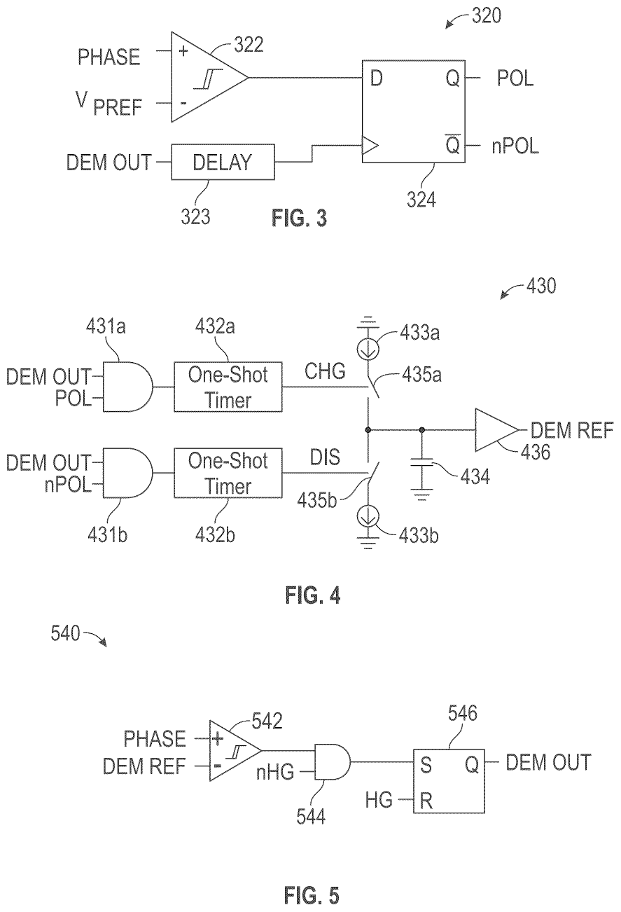

Polarity detection circuit 120 may be a circuit to determine the polarity of a phase node in DC-to-DC converter 110. Polarity detection circuit 120 may receive the phase node polarity, or a representative thereof, and may compare the phase node voltage against a reference voltage to determine whether the termination of the on time of the low-side gate drive in DC-to-DC converter 110 is terminated early (e.g., the phase node voltage is below ground) or late (e.g., the phase node voltage is above V_{IN}). Polarity detection circuit 120 may output the polarity of the phase node (e.g., positive or negative) to adaptive DEM offset circuit 130. A more detailed example of polarity detection circuit 120 is shown in FIG. 3.

Adaptive DEM offset circuit 130 may be a circuit to detect whether the low-side gate drive in DC-to-DC converter 110 may have been terminated early or late. For example, if the polarity of the phase node is positive, the low-side gate drive may have been terminated late and if the polarity of the phase node is negative, the low-side gate drive may have been terminated early. Adaptive DEM offset circuit 130 may also output an offset voltage based on the polarity of the phase node. The offset voltage may be output to DEM circuit 140. A more detailed example of adaptive DEM offset circuit 130 is shown in FIG. 4.

DEM circuit 140 may be a circuit to receive the offset voltage from adaptive DEM offset circuit 130 and output a control signal to control the state of the low-side gate drive to DC-to-DC converter 110. The control signal may be used to selectively terminate the on time of the low-side gate drive to more accurately time the termination of the on time of the low-side gate drive to mitigate a subsequent early or late termination. In some examples, the control signal output by DEM circuit 140 may be a logic value input to the low-side gate drive (e.g., a logic value of 1 turns the low-side gate drive on and a logic value of 0 turns the low-side gate drive off). A more detailed example of DEM circuit 140 is shown in FIG. 5.

FIG. 2 illustrates an DC-to-DC converter, according to examples of the present disclosure. In the example shown in FIG. 2, the DC-to-DC converter is a step-down or buck converter. DC-to-DC converter 210 is illustrated in FIG. 2 as including four main components: high-side power switch 211, low-side switch 212, inductor 214, and capacitor 215.

Low-side switch 212, which may be a transistor such as a FET or metal-oxide-semiconductor field-effect transistor (MOSFET), may be controlled by an input logic value, labelled “LG” in FIG. 2, from a DEM circuit, such as DEM circuit 140 shown in FIG. 1. If the on time of low-side switch 212 is terminated late, the current direction through inductor 214 may reverse, causing the voltage at phase node 216 to rapidly increase to above V_{IN} after termination of low-side switch 212, resulting in increased power dissipation. If the on time of low-side switch 212 is terminated early, the voltage at phase node 216 is pulled below ground by the current circulating through DC-to-DC converter 210. Specifically, because the current is flowing from ground to phase node 216 through low-side switch 212 and ground is a zero-volt reference, the voltage at phase node 216 will be pulled below ground for current to flow. Early termination also results in increased power dissipation over an accurately timed termination of low-side switch 212. The offset voltage from a DEM offset circuit, such as adaptive DEM offset circuit 130, may provide an offset voltage to the DEM circuit, such as DEM circuit 140, to achieve a more accurately timed termination of low-side switch 212 and mitigate the occurrence of early or late terminations of the on time of low-side switch 212.

DC-to-DC converter 210 may also include high-side power switch 211 which may be a second switch, such as a diode or transistor, and may be used to selectively provide the input voltage to DC-to-DC converter 210. The position of high-side power switch 211 may be controlled by input logic value labeled “HG” in FIG. 2. Capacitor 215 may be a capacitor that works in conjunction with inductor 214 to store energy. Capacitor 215 may have any suitable value, such as 1 mF.

DC-to-DC converter 210 is also illustrated as including error amplifier 213, current sensor 221, pulse width modulation (PWM) comparator 217, set-reset (SR) latch 218, inverter 220, and clock 219 which may be used to close the power supply loop and provide a fixed output voltage, V_{OUT}. Error amplifier 213 may compare the output voltage to a reference voltage. Current sensor 221 may sense the current of inductor 214. PWM comparator 217 may compare the signal from current sensor 221 with the output of error amplifier 213. The output of PWM comparator 217 may be provided to SR latch 218 and used to reset SR latch 218. SR latch 218 may latch the high-side gate drive signal (labelled “HG”) to high at every clock cycle and to low with each reset from PWM comparator 217. Inverter 220 may ensure that the low-side gate drive signal (labelled “LG”) is maintained at an opposite state of the high-side gate drive signal by outputting a signal (labelled “nHG”) that is opposite of the high-side gate drive signal. Clock 219 may provide a signal to SR latch 218 to signal the start of each switching cycle. Clock 219 may also provide a signal to fix the PWM frequency.

To implement DEM in a DC-to-DC converter, such as DC-to-DC converter 210, DEM comparator circuit 140 may be added to DC-to-DC converter 210. AND gate 222 may receive the output of inverter 220 and the output of DEM circuit 140 as inputs and output the low-side gate drive signal, LG. The output of DEM circuit 140 may occur earlier than if DEM comparator circuit 140 were not present (e.g., if the output of PWM comparator 217 were used to provide the low-side gate drive signal).

FIG. 3 illustrates a polarity detection circuit, according to examples of the present disclosure. Polarity detection circuit 320 may receive the voltage of the phase node of the DC-to-DC converter, such as phase node 216 shown in FIG. 2. Polarity detection circuit 320 may determine the polarity of the phase node based on the received voltage. Specifically, comparator 322 may compare the voltage of the phase node against a direct current reference voltage, labelled V_{PREF} in FIG. 3. The DC reference voltage may be any reference voltage, greater than ground and less than or equal to V_{IN}, in the system of which the DC-to-DC converter is a part. For example, V_{IN} may be selected as the reference voltage for DEM polarity detection circuit 320 because even if the voltage of the phase node oscillates after the synchronous switch is terminated, in the event of a late termination, the voltage at the phase node will rise above V_{IN} by the forward voltage drop of the high-side switch (e.g., the forward voltage drop of the body diode of the high-side switch) and in the event of a late termination, the phase node voltage will be less than ground, and the voltage of the phase node will not exceed V_{IN}. The polarity of the phase node immediately after the on time of the low-side gate drive is terminated may be used to determine if the termination of the on time occurred early (e.g., the phase node voltage is below ground) or late (e.g., the phase node voltage is above V_{IN}).

Polarity detection circuit 320 may include flip flop switch 324. Flip flop switch 324 may sample the output of comparator 322 (e.g., the polarity of the phase node) when the clock input sees a rising edge, provided by a delayed DEM OUT signal. The DEM OUT signal may be from a DEM circuit, such as DEM circuit 140 shown in FIG. 2 and described in more detail with respect to FIG. 5. Delay 323 may provide a short delay on the DEM signal from a DEM circuit, such as DEM circuit 140 shown in FIG. 1, labelled “DEM OUT” in FIG. 3. The delay provided by delay 323 may ensure that the sampling performed by flip flop switch 324 occurs slightly after the termination of the low-side gate drive, such as low side gate drive 212 shown in FIG. 2.

The output of flip flop switch 324 is determined by the polarity of the phase node during the current cycle of the clock, such as clock 219 shown in FIG. 2. Specifically, when the polarity of the phase node is positive (e.g., the voltage of the phase node is greater than the reference voltage), the output of Q of flip flop switch 324 may be one (1) and when the polarity of the phase node is negative (e.g., the voltage of the phase node is less than the reference voltage), the output of Q̅ flip flop switch 324 may be one (1). In FIG. 3, an output of Q is labeled “POL” and an output of Q̅ is labeled “nPOL.” The outputs of flip flop switch 324 (e.g., POL and nPOL) may be provided as inputs to an adaptive DEM offset circuit, such as adaptive DEM offset circuit 130 shown in FIG. 2 and as described in more detail with respect to FIG. 4.

FIG. 4 illustrates an adaptive DEM offset circuit, according to examples of the present disclosure. Adaptive DEM offset circuit 430 may receive the polarity signal from a polarity detection circuit, such as polarity detection circuit 320 shown in FIG. 3, and the current DEM OUT signal from DEM circuit 140. The DEM OUT signal may indicate whether the current in the inductor, such as inductor 214 shown in FIG. 2, is crossing zero. The polarity signal may be added to the DEM OUT signal at AND gates 431a and 431b. The output of AND gates 431a and 431b may be input to one shot timers 432a and 432b. One shot timers 432a and 432b may control the charge and discharge duration of capacitor 434. Specifically, one shot timer 432a outputs a logic value of 1 (labeled “CHG” in FIG. 4) when the polarity of the phase node is negative and one shot timer 432b outputs a logic value of 1 (labeled “DIS” in FIG. 4) when the polarity of the phase node is positive.

Adaptive DEM offset circuit 430 may receive current from current sources 433a and 433b. The size of current sources 433a and 433b may be any suitable amount. In some examples, current source 433a may have a different size than current source 433b. At switch 435a, when one shot timer 432a outputs CHG, switch 435a closes to provide current from current source 433a to capacitor 434 to charge capacitor 434. At switch 435b, when one shot timer 432b outputs DIS, switch 435b closes to provide the current from current source 433b to capacitor 434 to discharge capacitor 434. Thus the voltage level of capacitor 434 is raised and lowered by the opening and closing of switches 435a and 435b. The voltage level of capacitor 434 is buffered at buffer 436 and output as an offset voltage, labeled “DEM REF” in FIG. 4. The offset voltage, DEM REF, may be the reference for a DEM circuit, such as DEM circuit 140 shown in FIG. 2 and as described in more detail with respect to FIG. 5. The offset voltage may be forced to zero millivolts when the current through the inductor of the DC-to-DC converter, such as inductor 214 shown in FIG. 2, is not crossing zero.

The period of one-shot timers 432a and 432b, the strength of current sources 433a and 433b, and the value of capacitor 434 may determine the step size of the adjustment of DEM REF. These values may be adjusted based on the implementation of the adaptive DEM offset circuit and the DC-to-DC converter into which the adaptive DEM offset circuit is incorporated to provide the optimal step size and die area for the application.

FIG. 5 illustrates a DEM circuit, according to examples of the present disclosure. DEM circuit 540 may receive the voltage at the phase node (“PHASE”) and the offset voltage (“DEM REF”) from an adaptive DEM offset circuit. Comparator 542 compares the voltage at the phase node and the offset voltage and outputs a “1” if the voltage at the phase node is greater than the offset voltage or a “0” if the offset voltage is greater than the voltage at the phase node. The output of comparator 542 is added the inverted high-side gate drive signal, nHG, as described with respect to FIG. 2 above, at AND gate 544. The output of AND gate 544 is then provided to SR latch 546. SR latch 546 may be set when the high-side gate drive is low. SR latch 546 may be reset by the high-side gate drive signal, HG, every switching cycle to ensure that diode emulation mode is checked independently each cycle. SR latch 546 may output a logic value labeled “DEM OUT” in FIG. 5 indicating whether the low side gate drive in the DC-to-DC converter should be opened or closed. DEM OUT may be provided to the components of the DC-to-DC converter, such as AND gate 222 shown in FIG. 2, to control the position of the low-side gate drive.

DEM circuit 540 may be similar to a standard DEM circuit with the addition of the output of the adaptive DEM offset circuit, DEM REF. DEM REF may replace the reference value used in a standard DEM circuit, which may be a fixed value.

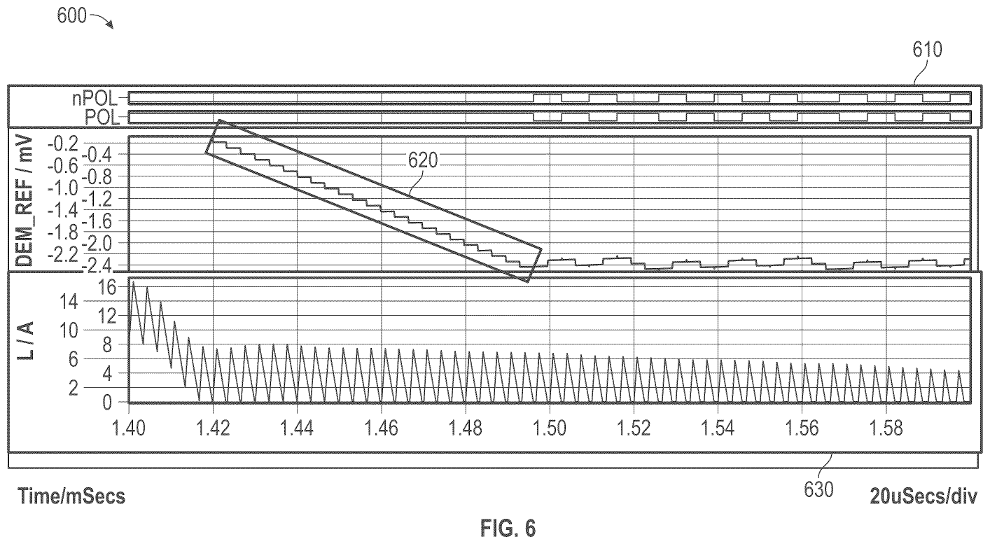

FIG. 6 illustrates simulation results of a DC-to-DC converter containing an adaptive DEM offset circuit, according to examples of the present disclosure. Graph 600 illustrates the current through the inductor of the DC-to-DC converter, such as inductor 214 shown in FIG. 2, in area 630 of graph 600. When the current through the inductor is not at or crossing zero, the offset voltage to the DEM comparator (labeled DEM_REF in FIG. 6) is forced to 0 mV. In the example shown in graph 600, at approximately 1.42 milliseconds, the current through the inductor reaches zero. At that time, the offset voltage (DEM REF) begins to be adjusted in steps until the polarity at the phase node changes. While in the example shown in area 620 of graph 600, the offset voltage is adjusted in 100 μV increments until the polarity of the phase node changes, in other examples, the increments may be any size.

Graph 600 illustrates the output from a polarity detection circuit, such as polarity detection circuit 320 shown in FIG. 3, in area 610 of graph 600. At approximately 1.495 milliseconds, the polarity of the phase node reverses. Once the polarity of the phase node reverses, the offset voltage increases until the polarity of the phase node reverses again. During steady state operation, the offset voltage may continue to increase and decrease between positive and negative polarity of the phase node to achieve accurate timing of the termination of the low-side gate drive in the DC-to-DC circuit, such as low-side switch 212 shown in FIG. 2.

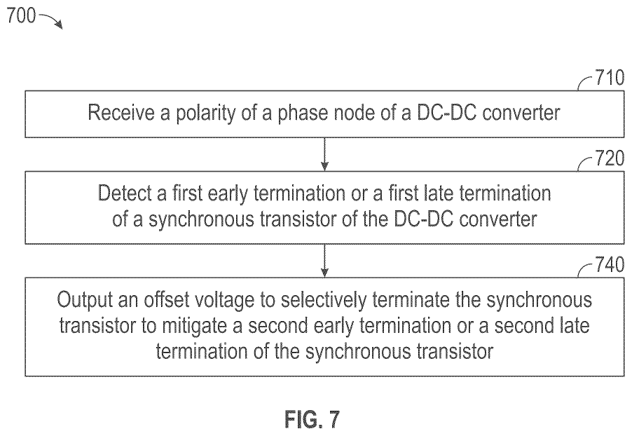

FIG. 7 illustrates a method performed for using an adaptive DEM circuit in a DC-DC converter, according to examples of the present disclosure. Method 700 may be implemented using an adaptive DEM offset circuit, such as adaptive DEM offset circuit 430 shown in FIG. 4, or any other circuit operable to implement method 700. Although examples have been described above, other variations and examples may be made from this disclosure without departing from the spirit and scope of these disclosed examples.

Method 700 may begin at block 710 where an adaptive DEM offset circuit may receive a polarity of a phase node of a DC-DC converter. The polarity of the phase node may be output to the adaptive DEM offset circuit by a polarity detection circuit, such as polarity detection circuit 320 shown in FIG. 3.

At block 720, the adaptive DEM offset circuit may detect a first early termination or a first late determination of an on time of a low-side gate drive in the DC-DC converter. The adaptive DEM offset circuit may detect the termination of the on time of the low-side gate drive and determine that the termination was early or late based on the polarity of the phase node immediately after the low-side gate drive on time is terminated. The termination may have occurred early when the phase node voltage is below ground or late when the phase node voltage is above V_{IN}.

At block 740, the adaptive DEM offset circuit may output an offset voltage to selectively terminate the on time of the low-side gate drive to mitigate a second early termination or a second late termination of the on time of the low-side gate drive. The adaptive DEM offset circuit may output the offset voltage by selectively charging a capacitor in the adaptive DEM offset circuit, such as capacitor 434 shown in FIG. 4. The offset voltage may be based on the polarity of the phase node received at block 710.

Although FIG. 7 discloses a particular number of operations related to method 700, method 700 may be executed with greater or fewer operations than those depicted in FIG. 7. In addition, although FIG. 7 discloses a certain order of operations to be taken with respect to method 700, the operations comprising method 700 may be completed in any suitable order.

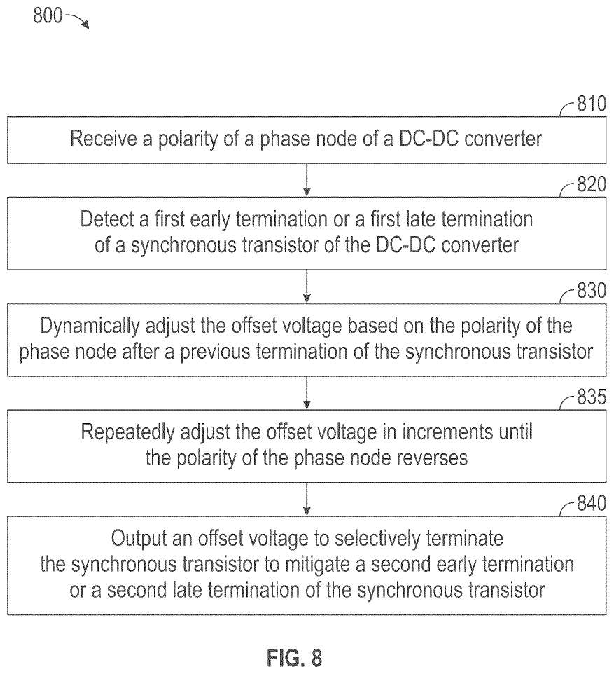

FIG. 8 illustrates a more detailed version of the method described in FIG. 7, according to examples of the present disclosure. Method 800 may be implemented using an adaptive DEM offset circuit, such as adaptive DEM offset circuit 430 shown in FIG. 4, or any other circuit operable to implement method 800. Although examples have been described above, other variations and examples may be made from this disclosure without departing from the spirit and scope of these disclosed examples.

Method 800 may begin at block 810 where an adaptive DEM offset circuit may receive a polarity of a phase node of a DC-DC converter. The polarity of the phase node may be output to the adaptive DEM offset circuit by a polarity detection circuit, such as polarity detection circuit 320 shown in FIG. 3.

At block 820, the adaptive DEM offset circuit may detect a first early termination or a first late determination of an on time of a low-side gate drive in the DC-DC converter. The adaptive DEM offset circuit may detect the termination of the on time of the low-side gate drive and determine that the termination was early or late based on the polarity of the phase node immediately after the low-side gate drive is terminated. The termination of the on time may have occurred early when the phase node voltage is below ground or late when the phase node voltage is above V_{IN}.

At block 830, the adaptive DEM offset circuit may dynamically adjust the offset voltage based on the polarity of the phase node after a previous termination of the on time of the low-side gate drive. The offset voltage may be dynamically adjusted by selectively charging a capacitor in the adaptive DEM offset circuit, such as capacitor 434 shown in FIG. 4. For example, the polarity of the phase node may be based on the previous termination of the on time of the low-side gate drive. When the polarity of the phase node is negative (e.g., the on time of the low-side gate drive previously was terminated early), the capacitor may be charged and when the polarity of the phase node is positive (e.g., the on time of the low-side gate drive previously was terminated late), the capacitor may be discharged.

At block 835, the adaptive DEM offset circuit may repeatedly adjust the offset voltage in increments until the polarity of the phase node reverses. For example, the capacitor in the adaptive DEM offset circuit may be charged in increments to create offset voltage increments. The offset voltage may be adjusted by these increments until the polarity of the phase node reverses as described in further detail with respect to FIG. 6. The offset voltage increments may have any suitable size. In some examples, the increments may be of equal magnitude and in other examples, the increments may be of different magnitude.

At block 840, the adaptive DEM offset circuit may output an offset voltage to selectively terminate the on time of the low-side gate drive to mitigate a second early termination or a second late termination of the on time of the low-side gate drive. The adaptive DEM offset circuit may output the offset voltage by selectively charging a capacitor in the adaptive DEM offset circuit, such as capacitor 434 shown in FIG. 4. The offset voltage may be based on the polarity of the phase node received at block 810.

Although FIG. 8 discloses a particular number of operations related to method 800, method 800 may be executed with greater or fewer operations than those depicted in FIG. 8. In addition, although FIG. 8 discloses a certain order of operations to be taken with respect to method 800, the operations comprising method 800 may be completed in any suitable order.

While the adaptive DEM zero crossing detection is illustrated with reference to a buck converter, the adaptive DEM zero crossing detection circuitry may also be used in any DC-DC converter topology including buck-boost and synchronous boost topologies.

Although examples have been described above, other variations and examples may be made from this disclosure without departing from the spirit and scope of these disclosed examples.

1. An apparatus, comprising:
a polarity detection circuit to identify the polarity of a phase node of a DC-DC converter; and
an adaptive diode emulation mode (DEM) offset circuit to:
detect a first early termination or a first late termination of an on time of a low-side gate drive of the DC-DC converter based on the identified polarity of the phase node; and
output an offset voltage to selectively terminate on time of the low-side gate drive to mitigate a second early termination or a second late termination of the low-side gate drive, a value of the offset voltage based on a polarity of the phase node of the DC-DC converter;
wherein the second early termination occurs after the first early termination and the second late termination occurs after the first late termination.

2. The apparatus of claim 1, wherein the adaptive DEM offset circuit is to dynamically adjust the offset voltage based on the polarity of the phase node.

3. The apparatus of claim 2, wherein the adaptive DEM offset circuit is to repeatedly adjust the offset voltage in increments until the polarity of the phase node reverses.

4. The apparatus of claim 1, wherein the adaptive DEM offset circuit is to receive a polarity of a phase node of a DC-DC converter.

5. The apparatus of claim 1, wherein the adaptive DEM offset circuit is to detect the first early termination through detection of a voltage of the phase node being pulled below ground.

6. The apparatus of claim 1, wherein the adaptive DEM offset circuit is to detect the first late termination through detection of a voltage of the phase node being pulled above the input voltage.

7. The apparatus of claim 1, wherein the offset voltage is approximately zero when a current through the DC-DC converter flows in a positive direction.

8. An apparatus, comprising:
a DC-DC converter including a low-side gate drive and a phase node;
a polarity detection circuit to identify a polarity of the phase node;
an adaptive diode emulation mode (DEM) offset circuit to:
receive the identified polarity of the phase node from the polarity detection circuit;
detect a first early termination or a first late termination of an on time of the low-side gate drive based on the identified polarity of the phase node; and
output an offset voltage, a value of the offset voltage based on the polarity of the phase node; and
a diode emulation mode (DEM) circuit to:
receive the offset voltage; and
selectively terminate the on time of the low-side gate drive to mitigate a second early termination or a second late termination of the low-side gate drive.

9. The apparatus of claim 8, wherein the adaptive DEM offset circuit is to dynamically adjust the offset voltage based on the polarity of the phase node.

10. The apparatus of claim 9, wherein the adaptive DEM offset circuit is to repeatedly adjust the offset voltage in increments until the polarity of the phase node reverses.

11. The apparatus of claim 10, wherein the increments are of equal magnitude.

12. The apparatus of claim 8, wherein the adaptive DEM offset circuit is to detect the first early termination through detection of a voltage of the phase node being pulled below ground.

13. The apparatus of claim 8, wherein the adaptive DEM offset circuit is to detect the first late termination through detection of a voltage of the phase node being pulled above the input voltage.

14. The apparatus of claim 8, wherein the offset voltage is approximately zero when a current through the DC-DC converter is greater than zero.

15. A method, comprising:
receiving a polarity of a phase node of a DC-DC converter;
detecting a first early termination or a first late termination of an on time of a low-side gate drive of the DC-DC converter based on the received polarity of the phase node; and
outputting an offset voltage to selectively terminate the on time of the low-side gate drive to mitigate a second early termination or a second late termination of the on time of the low-side gate drive, a value of the offset voltage based on a polarity of a phase node.

16. The method of claim 15, comprising dynamically adjusting the offset voltage based on the polarity of the phase node after a previous termination of the low-side gate drive.

17. The method of claim 16, comprising repeatedly adjusting the offset voltage in increments until the polarity of the phase node reverses.

18. The method of claim 17, wherein the increments are of equal magnitude.

19. The method of claim 15, wherein detecting a first early termination includes detecting a voltage of the phase node being pulled below ground.

20. The method of claim 15, wherein detecting a first late termination includes detecting a voltage of the phase node being pulled above the input voltage.
